(19) United States
(12) Patent Application Publication
(10) Pub. No.: US 2018/0347752 A1
(43) Pub. Date: Dec. 6, 2018

(54) WORKSITE SAFETY DEVICE USING LIDAR

(71) Applicant: VHS IP PTY LTD, Ormeau (AU)

(72) Inventors: Neil COSTELLO, Yatala (AU); Jack BEACH, Yatala (AU)

(21) Appl. No.: 15/779,243

(22) PCT Filed: Nov. 18, 2016
(86) PCT No.: PCT/AU2016/051116

§ 371 Date: May 25, 2018

(30) Foreign Application Priority Data
Nov. 25, 2015 (AU) 2015904871

(51) Int. Cl. F16P 3/14; G01S 17/32; G01S 17/88; G08B 21/22; G08B 21/02

(52) U.S. Cl. CPC F16P 3/144; G01S 17/32; G08B 21/02; G08B 21/22; G01S 17/88

(57) ABSTRACT

A perimeter safety device comprises a laser, detector, controller and an alarm. The laser emits optical laser radiation into a monitored zone. Laser radiation reflected from an object in the monitored zone is detected by the detector and a range to the object is determined by the controller. An alarm is activated if the object is determined to be in a location that is not authorized. The invention also reside in a network of perimeter safety devices that together define a monitored area formed of monitored zones. A central controller may define a pre-defined “safe” path through the monitored area.

### FIELD OF THE INVENTION

The present invention relates to the general field of workplace safety. More particularly, the invention relates to a device utilizing Lidar to set a perimeter and to monitor for any breach of the perimeter.

### BACKGROUND TO THE INVENTION

A building work site is intrinsically a dangerous place. There are usually many pieces of heavy equipment moving around the site. Workers must move around the site taking heed to avoid the path of a moving vehicle or shifting equipment. Due to limited vision from many vehicles it is difficult for the vehicle operator to take account of people near the vehicle. The onus is therefore on the workers to exercise care. Risk on the work site is reduced by good training, appropriate movement control rules and, in some cases, staff specifically trained for security.

Notwithstanding the best efforts to minimise risk there is still room for improvement by using available technology.

An even greater safety risk is untrained people, such as civilians, gaining inadvertent access to a work site. Various mechanisms have been developed to limit this risk. The simplest approach has been to post sentries around a work site who watch for any unauthorised or inadvertent access. This solution is inherently limited by human error, and therefore a better solution is needed. Even if human error could be reduced to an acceptable level, there would still be a problem with the cost of employing staff who are, in essence, spending the majority of their time unproductively.

One technology that offers promise for perimeter security is Lidar. Lidar uses a laser to detect the location of an object. A well-known application of Lidar is in surveying to build a point cloud image of a scene. In this application the laser is scanned in azimuth and elevation. A detector located with the laser detects light reflected from an object that the beam from the laser hits. The laser beam is pulsed so the time of flight from the pulse leaving the laser till the detector measures the reflected pulse can be accurately measured. The combination of the azimuth and elevation together with the measured range gives a point on the object. Repetitively recording the point data builds a “point cloud” image of the scene in a dome around the laser.

### SUMMARY OF THE INVENTION

In one form, although it need not be the only or indeed the broadest form, the invention resides in a perimeter safety device comprising:
a laser that emits optical laser radiation towards a monitored zone;
a detector that detects reflected optical laser radiation from an object in the monitored zone;
a controller that:
   generates an outbound signal to operate the laser to emit modulated laser light;
   receives an inbound signal from the detector that indicates reflected optical laser radiation;
   calculates a range to the object from the outbound signal and the inbound signal;
and an alarm that is activated by the controller if the range to the object is determined to be in a monitored range of the monitored zone.

The perimeter safety device may further include an input device connected to the controller to adjust the monitored range.

The alarm may be a tactile, audible or visual alarm. The perimeter safety device may further include a transmitter that transmits a signal to a remote alarm. The controller may also generate a safety control signal that is transmitted by the transmitter to other equipment for safety purposes, such as shut down.

In a further form the invention resides in a method of providing safety in an area including the steps of:
emitting a laser beam into a monitored zone;
receiving a laser beam reflection from an object in the monitored zone;
calculating a range to the object; and
generating an alarm if the range to the object is within a monitored range of the monitored zone.

The method may further include the step of shutting down equipment if an object is detected in the monitored range of the monitored zone.

In a yet further form the invention resides in a network of perimeter safety devices together defining a monitored area made up of multiple monitored zones.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 is a sketch of a perimeter safety device;

FIG. 2 is a block diagram of the perimeter safety device of FIG. 1;

FIG. 3 is a graphical display of range selection for the perimeter safety device of FIG. 1;

FIG. 4 is a block diagram of an alternate embodiment of a perimeter safety device;

FIG. 5 is a sketch of the circuitry of the perimeter safety device of FIG. 4;

FIG. 6 is a sketch of a wearable warning device associated with the perimeter safety device of FIG. 4;

FIG. 7 is a sketch of a safety shut down option for the perimeter safety device of FIG. 4;

FIG. 8 is an alternate perimeter safety device for safety within a perimeter around a moving location; and

FIG. 9 displays a network of perimeter safety devices monitoring a monitored area.

### DETAILED DESCRIPTION OF THE INVENTION

Embodiments of the present invention reside primarily in a perimeter safety device that utilises a laser rangefinder, preferably a Lidar device. Accordingly, the elements of the device have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order. Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

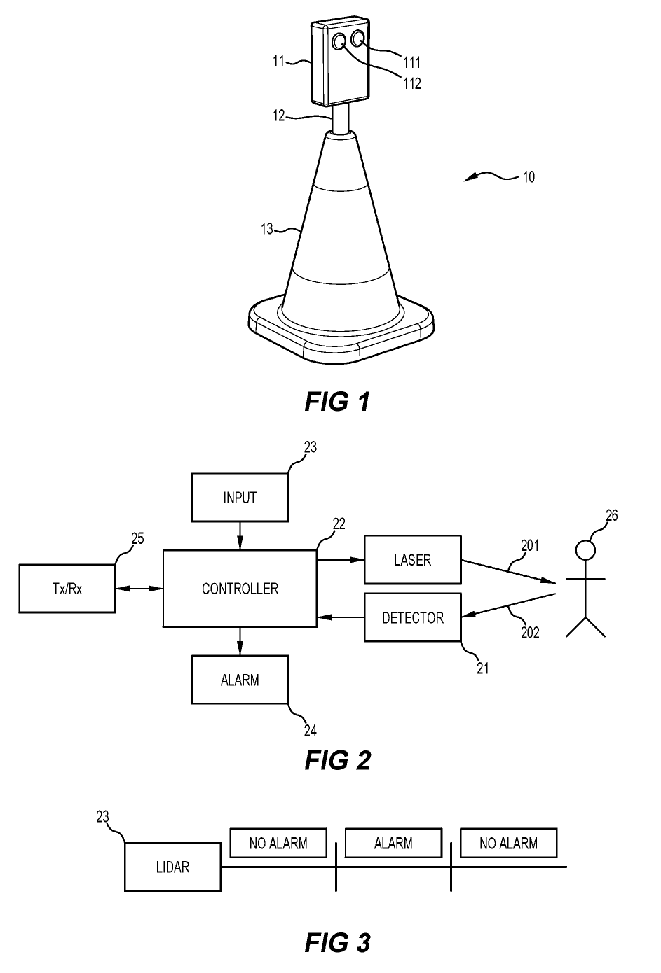

Referring to FIG. 1 there is a shown a sketch of a perimeter safety device 10. The perimeter safety device 10 is based on a laser rangefinder, most suitably a Lidar device 11. As described above, a Lidar device uses a laser to determine the location of an object. In the embodiment of FIG. 1 the Lidar is mounted on a post 12 that elevates the Lidar 11 to a suitable height for the objects that are to be located. The post 12 is mounted on a base 13. It is convenient for many industrial applications for the base to be a coloured, cone-shaped base commonly known as a witch's hat.

The Lidar 11 has an optical element 111 from which a laser beam is emitted and a window 112 that collects laser radiation that is reflected from an object that crosses the beam.

Referring to FIG. 2, there is shown a block diagram of the main elements of the Lidar 11. The Lidar 11 includes a laser 20, a detector 21 and a controller 22. The controller 22 controls the operation of the laser to emit a laser beam 201. The laser beam 201 is modulated so as to provide a time base for further processing, as described below. One approach to generate the modulation is to pulse the laser so as to apply an amplitude modulation to the laser beam. This may be done by repetitively turning the laser on and off. Another approach is to use a continuous wave (CW) laser and to chop the beam with a mechanical or electro-optic chopper. The amplitude modulation need not have a modulation depth of 100%. Alternatively some other form of modulation, such as phase modulation, can be applied to the laser beam. The modulation signal is generated by the controller 22 and drives the laser 20.

In use, the laser beam 201 strikes an object 26 and some of the laser beam 201 is reflected or scattered as reflected laser light 202. The reflected laser light 202 is detected by detector 21 and a detection signal is generated. The controller compares the modulation signal and the detection signal and calculates the time of flight of the reflected signal. The time of flight is converted to a distance between the Lidar 11 and the object 26.

The controller 22 also generates an alarm signal that activates alarm 24. The parameters for activation of alarm 24 may be input by a user using the input 23. One useful setting is to only generate an alarm between certain range limits, as shown in FIG. 3. To achieve the configuration of FIG. 3 a user inputs a minimum range and a maximum range using the input 23. The input 23 may be a keyboard, touch screen, or simply dip switches. A typical alarm range may be between 2 meters and 10 meters. Any object detected by the Lidar at a range less than 2 meters will not trigger an alarm. Similarly, any object detected by the Lidar at greater than 10 meters will not trigger an alarm. This configuration is particularly useful for safety at the entrance to a work site where the perimeter safety device 10 is positioned adjacent a gate which is, say, 2 meters wide. Normal movement through the gate does not trigger an alarm but any movement beyond the gate does generate an alarm.

The perimeter safety device 10 may also be configured with the converse settings. That is, a monitored entry may generate an alarm to count people moving in and out but no alarm is generated otherwise because physical security (for example a wall) prevents movement either side of the entry.

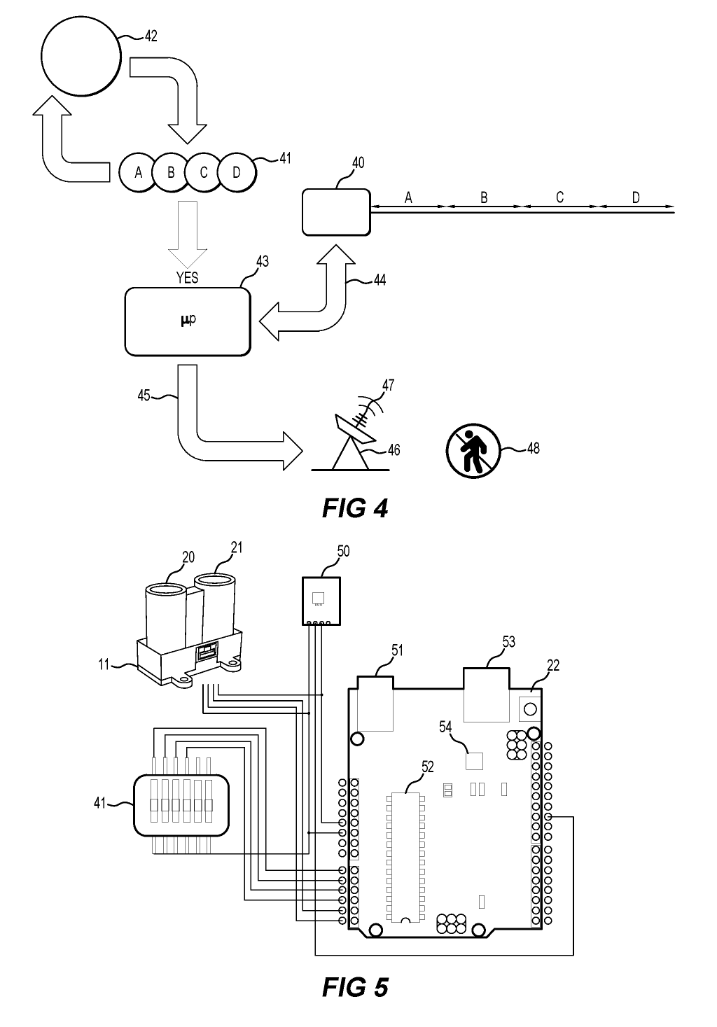

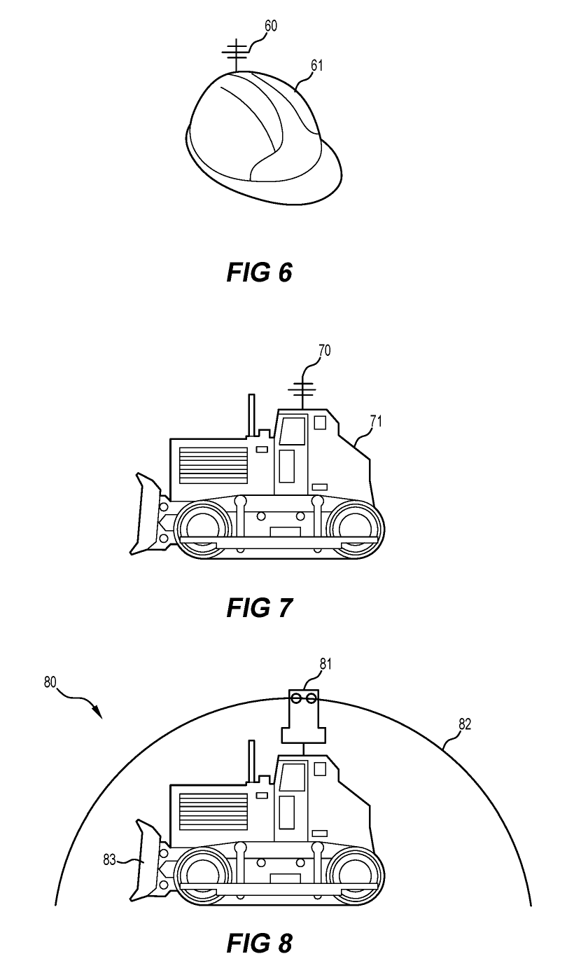

Referring now to FIG. 4, an alternate embodiment is shown. The Lidar device 40 is shown with 4 preset monitored ranges, A, B, C and D. For instance, these may be set according to the following table:

| Preset | Min range | Max range |
|---|---|---|
| A | 0 | 2 m |
| B | 2 m | 4 m |
| C | 4 m | 6 m |
| D | 6 m | 8 m |

The preset distances are set by dip switches 41 that are activated at a user interface 42 to set a processor 43. The processor 43 receives signals 44 from the Lidar 40 and compares whether the Lidar signal 43 is within the preset range (A, B, C or D).

If a target is detected with the preset range the processor 43 sends an alarm signal 45 to a transmitter 46 that generates a wireless signal 47 to cause various actions, such as illuminate a warning sign 48.

One suitable combination of elements to effect the device of FIG. 4 is shown in FIG. 5. The Lidar unit 11 with laser 20 and detector 21 is an OEM item available from, for instance, Pulsed Light LLC of Bend, Oreg., USA. The Lidar unit 11 includes a microprocessor 50 that outputs a distance from the Lidar unit 11 to an object that reflects a portion of the laser beam. The output from the microprocessor 50 connects to a controller 22. The controller 22 is provided with power through jack 51. The controller includes an ATmega328 microcontroller 52 (or similar device) that performs the functions described herein. Programming of the microcontroller 52 may be done through USB 53. Dip switches 41 provide selectable activation of various inputs to the microcontroller 52 to set the predefined monitored ranges (A, B, C, D). If the signal from the Lidar unit falls within the preset monitored range the Tx/Rx 54 is activated and various alarm conditions occur.

One such alarm condition is the transmitted signal 47 is received by a receiver 60 on a hard hat 61 work by all or some of the workers at the worksite. The received signal may activate a tactile, audible and/or visual alarm to warn the wearer hard hat 61 that a perimeter breach has occurred. Another alternative is that the transmitted signal 47 may be received on receiver 70 on a vehicle 71 on the worksite. The received signal may activate a tactile, audible and/or visual alarm to warn the driver of the vehicle 71, but may go further and shut down the vehicle. Various possible levels of shut down may be possible from merely stopping movement of elements of the vehicle or stopping the vehicle entirely, including the engine.

A further embodiment of a perimeter safety device 80 is shown in FIG. 8. In this embodiment the perimeter safety device includes a Lidar 81 as described above but the Lidar 81 collects point cloud data within a dome 82 surrounding the vehicle 83. The dome 82 moves with the vehicle 83 so it effectively gives a perimeter of safety at preset distances from the vehicle. The Lidar 81 collects range, elevation and azimuth information for any object that reflects laser light back to the Lidar 81. In one form the range data is compared to a preset range in the manner described above. For instance, an alarm may activate if any object is detected within 3 metres of the vehicle 83. The alarm may be audible, tactile and/or visual. The alarm may also be more interventionist by stopping further movement of the vehicle 83 by, for instance, activating the brakes.

The specific location of the detected object may be reported to the driver of the vehicle via a display (not shown). Because a Lidar unit can collect range, azimuth and elevation it is possible to give a precise indication of the location of the detected object.

It will be appreciated that a similar embodiment to that described with respect to FIG. 8 can be operated statically. In such an embodiment the Lidar is mounted on a static base, such as a tripod and monitors a set area around the tripod. The Controller is configured to ignore any movement within a predefined path through the monitored set area. That is to say, as long as a person remains on the pre-defined path the Lidar will not raise an alarm. If there is any movement off the pre-defined path an alarm registers as outlined above.

Although the embodiments described above have utilized dip switches to set monitored range, the invention is not limited to this implementation. One variation may involve deliberately blocking the beam at a specific location and activating the Lidar to record the distance to the location as a minimum or maximum range and then moving to another location to repeat the procedure. The two recorded positions then define the monitored range (either inside or outside the space between the recorded locations. This could be done as a single person operation using a small transmitter to activate the Lidar and initiate a measurement.

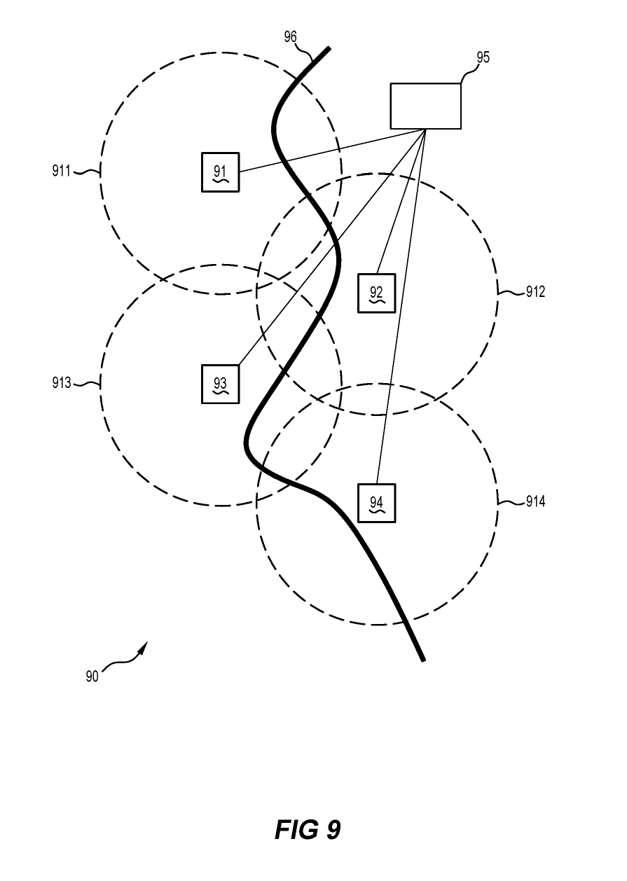

It is envisaged that a worksite may have multiple perimeter safety devices 10. It may be advantageous to network the devices 10 and thus provide a higher level of security across the site. Networking may be provided by Bluetooth® technology or other wireless protocols. A networked system allows the possibility of intruder tracking as the sequential location of detected objects can be recorded at a central controller. An example of a networked embodiment 90 is shown in FIG. 9. There are shown four perimeter safety devices 91, 92, 93, 94 with monitored zones 911, 912, 913 and 914 respectively. The controllers of each perimeter safety devices 91, 92, 93, 94 are connected to a central controller 95. The connection may be a physical cable but more conveniently the connection is a wireless connection. The controllers each define a monitored path in their respective zone which together define a pre-defined path 96 which is monitored by the central controller 95. Any movement on the predefined path does not trigger an alarm but movement of the pre-defined path triggers an alarm. The alarm may be generated by the local controllers or the network controller. The central controller may also have an associated display of the monitored area on which movement of all objects in the monitored area maybe displayed.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A perimeter safety device comprising:
a laser that emits optical laser radiation towards a monitored zone;
a detector that detects reflected optical laser radiation from an object in the monitored zone;
a controller that:
generates an outbound signal to operate the laser to emit modulated laser light;
receives an inbound signal from the detector that indicates reflected optical laser radiation;
calculates a range to the object from the outbound signal and the inbound signal;
an input device connected to the controller for adjusting the monitored range; and an alarm that is activated by the controller if the range to the object is determined to be in a monitored range of the monitored zone.

2. (canceled)

3. The perimeter safety device of claim 1 wherein the alarm is a tactile, audible or visual alarm.

4. The perimeter safety device of claim 1 further including a transmitter that transmits a signal to a remote alarm.

5. The perimeter safety device of claim 1 wherein the controller generates a safety control signal that is transmitted by the transmitter to other equipment.

6. The perimeter safety device of claim 5 wherein the safety control signal is a shutdown signal.

7. The perimeter safety device of claim 1 wherein the modulated laser light is modulated in amplitude or phase.

8. The perimeter safety device of claim 1 wherein the laser emits optical radiation along a line and the alarm is generated if an object crosses the line.

9. The perimeter safety device of claim 1 wherein the laser emits optical radiation along into a dome about the laser and the alarm is generated if an object moves within the dome.

10. The perimeter safety device of claim 9 when attached to a vehicle such that the dome moves with the vehicle.

11. A method of providing safety in an area including the steps of:
emitting a laser beam into a monitored zone;
adjusting a monitored range in the monitored zone using an input device connected to a controller;
receiving a laser beam reflection from an object in the monitored zone;
calculating a range to the object; and
generating an alarm if the range to the object is within the monitored range of the monitored zone.

12. The method of claim 11 further including the step of shutting down equipment if an object is detected in the monitored range of the monitored zone.

13. The method of claim 11 wherein the laser beam is modulated and the step of calculating a range to the object is by comparing the modulation of the laser beam emitted into the monitored zone with the modulation of the laser beam reflection from the object in the monitored zone.

14. The method of claim 13 wherein the modulation is amplitude modulation or phase modulation.

15. The method of claim 11 further including the step of transmitting an alarm signal to a remote location.

16. The method of claim 15 wherein the alarm signal is a safety control signal that is transmitted to other equipment.

17. The method of claim 16 wherein the safety control signal is a shutdown signal that causes the other equipment to shut down.

18. A network of multiple perimeter safety devices of claim 1 each perimeter safety device monitoring a monitored zone, the monitored zones collectively forming a monitored area.

19. The network of claim 18 wherein the monitored ranges of the perimeter safety devices together define a pre-defined path through the monitored area, such that an alarm is activated if an object is detected off the predefined path.

20. The network of claim 18 further comprising a central controller in signal communication with each controller of the multiple perimeter safety devices, wherein the central controller records sequential locations of objects moving in the monitored area.

21. The network of claim 18 wherein the central controller comprises an input device for adjusting the monitored ranges so as to define a path through the monitored zones which will not generate an alarm.
